(19) United States
(12) Patent Application Publication
(10) Pub. No.: US 2014/0049223 A1
(43) Pub. Date: Feb. 20, 2014

(54) RECHARGEABLE PROGRAMMABLE INTELLIGENT VARIABLE OUTPUT BATTERY MODULE

(71) Applicant: Karl Hermann Berger, Clifton Beach (AU)

(72) Inventor: Karl Hermann Berger, Clifton Beach (AU)

(21) Appl. No.: 13/969,798

(22) Filed: Aug. 19, 2013

(30) Foreign Application Priority Data
Aug. 17, 2012 (AU) 2012903558

(51) Int. Cl. H02J 7/00

(52) U.S. Cl. CPC H02J 7/0063
USPC 320/135

(57) ABSTRACT

A battery module of the present invention is described for providing programmable variable power output to a device. The battery module has a body, a first contact located at a first end of the body, a second contact located at a second end of the body, a battery received in the body, and a battery controller. The first contact includes at least one electrical contact surface having concentric raised and recessed surfaces. The second contact has at least one electrical contact surface that includes a nipple extending outwardly therefrom. The battery controller is located in the body, and is in electrical communication with the first contact, the second contact and the battery. The battery controller is programmed to monitor an electrical demand by the device and to control an electrical discharge from the battery.

### CROSS-REFERENCE TO RELATED APPLICATION

The present application claims priority under 35 U.S.C. 119(a) to Australia (AU) patent application number 2012903558 filed Aug. 17, 2012, which AU patent application is incorporated herein by reference in its entirety.

### FEDERALLY SPONSORED RESEARCH

Not applicable

### SEQUENCE LISTING OR PROGRAM

Not applicable

### BACKGROUND OF THE INVENTION

1. Field of the Invention

The present invention relates to a rechargeable programmable intelligent variable output battery module for use in connection with providing a replacement battery for a device which can be programmed to supply power output demanded by the device.

2. Description of the Prior Art

The use of rechargeable batteries is known in the prior art. However, these known rechargeable batteries are limited in that they are not able to be programmed to supply a specific power output that corresponds with the device the batteries are powering.

Therefore, a need exists for a new and improved rechargeable programmable intelligent variable output battery module that can be used for providing a replacement battery for a device which can be programmed to supply power output demanded by the device. In this regard, the present invention substantially fulfills this need. In this respect, the rechargeable programmable intelligent variable output battery module according to the present invention substantially departs from the conventional concepts and designs of the prior art, and in doing so provides an apparatus primarily developed for the purpose of providing a replacement battery for a device which can be programmed to supply power output demanded by the device.

### SUMMARY OF THE INVENTION

In view of the foregoing disadvantages inherent in the known types of rechargeable batteries now present in the prior art, the present invention provides an improved rechargeable programmable intelligent variable output battery module, and overcomes the above-mentioned disadvantages and drawbacks of the prior art. As such, the general purpose of the present invention, which will be described subsequently in greater detail, is to provide a new and improved rechargeable programmable intelligent variable output battery module and method which has all the advantages of the prior art mentioned heretofore and many novel features that result in a rechargeable programmable intelligent variable output battery module which is not anticipated, rendered obvious, suggested, or even implied by the prior art, either alone or in any combination thereof.

To attain this, the present invention essentially comprises a battery module for providing programmable variable power output to a device. The battery module has a body, a first contact located at a first end of the body, a second contact located at a second end of the body, a battery received in the body, and a battery controller. The battery controller is located in the body, and is in electrical communication with the first contact, the second contact and the battery. The battery controller is programmed to monitor an electrical demand by the device and to control an electrical discharge from the battery.

The first contact includes at least one electrical contact surface having concentric raised and recessed surfaces. The second contact has at least one electrical contact surface that includes a nipple extending outwardly therefrom.

The battery controller of the present invention may additionally include a discharge controller, a communication controller, and a GPS module.

There has thus been outlined, rather broadly, the more important features of the invention in order that the detailed description thereof that follows may be better understood and in order that the present contribution to the art may be better appreciated.

The invention may also include an RCA unit can be attached to and in communication with the first contact. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved rechargeable programmable intelligent variable output battery module that has all of the advantages of the prior art rechargeable batteries and none of the disadvantages.

It is another object of the present invention to provide a new and improved rechargeable programmable intelligent variable output battery module that may be easily and efficiently manufactured and marketed.

An even further object of the present invention is to provide a new and improved rechargeable programmable intelligent variable output battery module that has a low cost of manufacture with regard to both materials and labor, and which accordingly is then susceptible of low prices of sale to the consuming public, thereby making such rechargeable programmable intelligent variable output battery module economically available to the buying public.

Still another object of the present invention is to provide a new rechargeable programmable intelligent variable output battery module that provides in the apparatuses and methods of the prior art some of the advantages thereof, while simultaneously overcoming some of the disadvantages normally associated therewith.

Even still another object of the present invention is to provide a rechargeable programmable intelligent variable output battery module for providing a replacement battery for a device which can be programmed to supply power output demanded by the device. This allows for the power discharge of the battery to the device to be programmed or controlled depending on the power demands of the device, thereby to maximize the power life of the battery.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of an embodiment of the rechargeable programmable intelligent variable output battery module constructed in accordance with the principles of the present invention, with the phantom lines depicting environmental structure and forming no part of the claimed invention.

FIG. 2 is a cross-sectional view of the rechargeable programmable intelligent variable output battery module taken along line 2-2 in FIG. 1.

FIG. 3 is an enlarged cross-sectional view of a section of the present invention taken from FIG. 2.

FIG. 4 is an enlarged cross-sectional view of a section of the present invention taken from FIG. 2.

FIG. 5 is a perspective view of the alternate embodiment rechargeable programmable intelligent variable output battery module of the present invention.

FIG. 6 is a cross-sectional view of the alternate embodiment rechargeable programmable intelligent variable output battery module taken along line 6-6 in FIG. 5.

The same reference numerals refer to the same parts throughout the various figures.

### DETAILED DESCRIPTION OF THE INVENTION

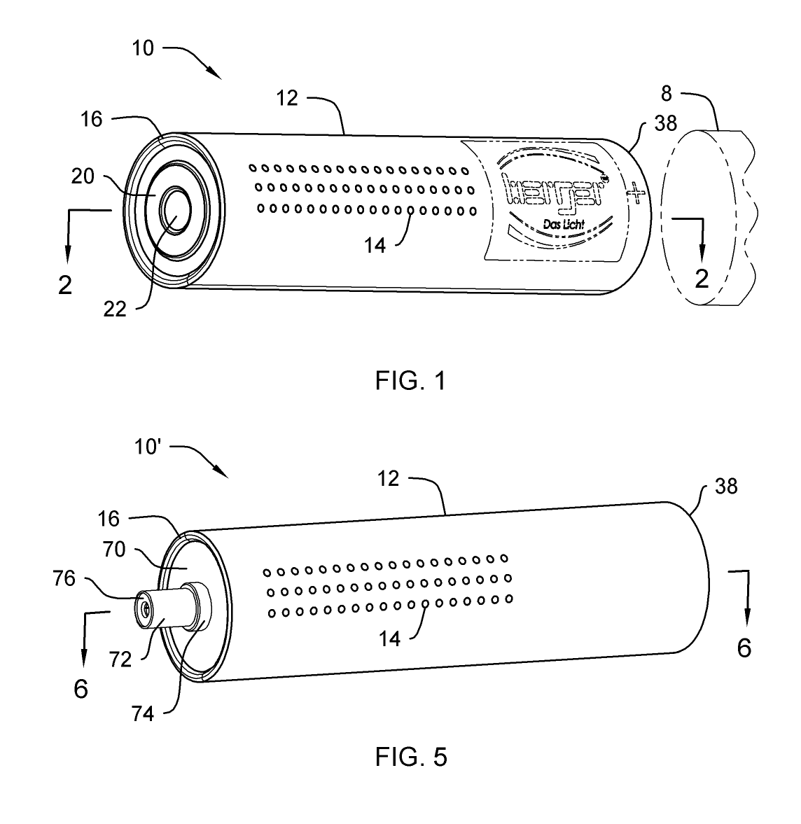

Referring now to the drawings and particularly to FIGS. 1-6, an embodiment of the rechargeable programmable intelligent variable output battery module of the present invention is shown and generally designated by the reference numeral 10.

In FIG. 1, a new and improved rechargeable programmable intelligent variable output battery module (hereinafter “battery module”) 10 of the present invention for providing a replacement battery for a device 8 which can be programmed to supply power output demanded by the device is illustrated and will be described.

The battery module 10 replaces a regular or existing battery (rechargeable or single way) of a device 8, such as but not limited to a flashlight or any other device operated by batteries. The battery module 10 can be programmed to supply the power output demanded by the device 8 and modulate its power output automatically based upon analysis of the current demanded of the receiving device 8, for example but not limited to the LED lights of a flashlight.

The battery module 10 can be in the size of the most common used battery sizes, but not limited to namely D-cells.

An internal intelligent controller monitors constantly the demand by the external device 8 and makes decisions based on the time duration between current demands. This leads to the switching of different power output modes beginning with a full power output to different current limited output modes. The different current limited output modes can be, but not limited to, 100%, 50%, 25%, and 12.5% or pulsed mode, for example but not limited to, slow flashing (i.e. 2×per second) or strobe function.

The battery module 10 can be used to but not limited to, convert a non-rechargeable or rechargeable flashlight to an intelligent rechargeable flashlight without any mechanically alterations required. Just replace the original single way or rechargeable battery with the battery module 10.

The battery module 10 monitors and analyses the operation of a power switch (not shown) of the device 8 and if activated in an on-off-on sequence (length of time in-between switching is variable and programmable) the module can change/switch the power output delivery modes from 100%, 50%, 25%, 12.5%, flashing, strobe and so on.

For example a standard non-rechargeable or rechargeable flashlight (or lighting device which uses batteries) can be converted to an intelligent device with multiple modes by simply replacing its standard batteries with the battery module 10.

The battery module 10 can be fitted out with either a rechargeable battery or a single way nonrechargeable battery. The battery module 10 can be recharged via several different ways of recharging, i.e. conventional via plug in socket or through inductive charging.

By monitoring the power switch and its successive switching with measuring the length of the time between the switching, the intelligent internal controller delivers the programmed power output requested by the user through the switching.

The different modes will enable the user to extend the power output of the battery module (battery life) i.e. 50% will give double time of light output compared to 100%.

Lower power outputs are provided by either pulse width modulation (rapid switching of the output current) or a current limiting circuit which reduces the output voltage to maintain a programmed current delivery.

To maximize power availability and therefore light output, the internal controller may depending on the state of charge of the battery switch to a lower power output mode automatically after a sequence of warning flashes to the user to indicate the battery status and extend the time power is available to the light source.

Different modes of these functions can be programmed into the battery module 10.

The battery module 10 may have a GPS module integrated in its circuitry which can be activated by the user or deactivated via a coded sequential operation of the power switch to enable the user to be located in an event of emergency.

More particularly, as best illustrated in FIG. 1, the rechargeable programmable intelligent variable output battery module 10 has a body 12, a negative contact end 20, and a positive contact end 38.

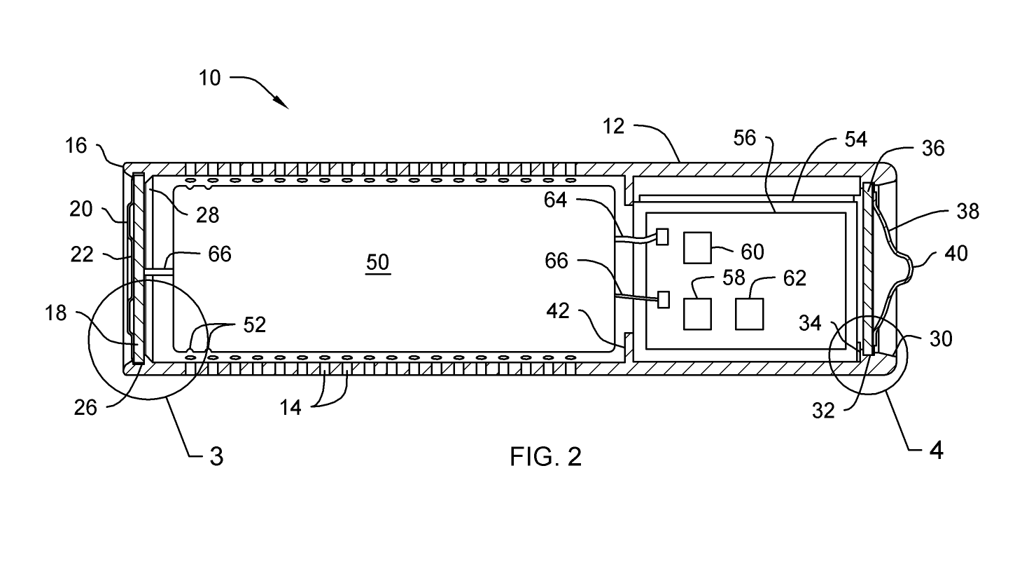

Referring to FIG. 2, the body 12 generally has a cylindrical configuration with first and second ends, but it can have any geometric configuration which corresponds with a battery of the device 8 that is to be replaced. The body features a plurality of ventilation holes 14 defined therethrough. The ventilation holes 14 are in communication with a hollow interior of the body 12.

The first end of the body 12 includes an interiorly tapering first edge 16, an interiorly tapering first lip 28 in a spaced apart relationship with the first edge 16, and a first groove 26 defined between the first edge 16 and first lip 28 along an interior circumference of the body 12. The first edge 16 and the first lip 28 having a central defined opening that is in communication with the hollow interior for the body 12.

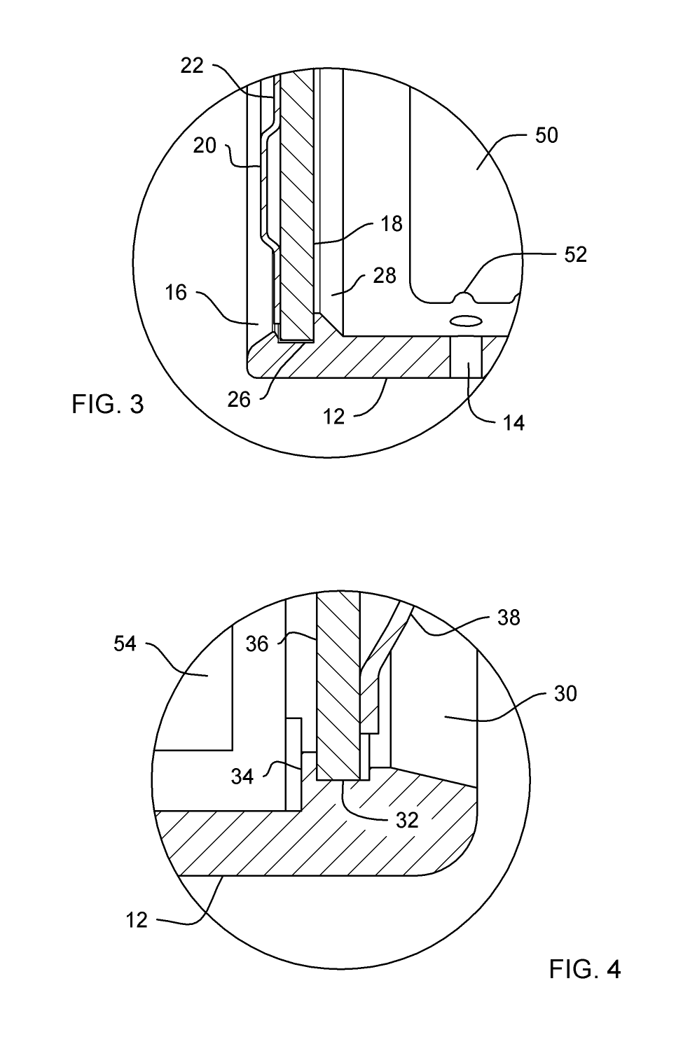

A negative printed circuit board or contact (hereinafter “−ye pcb”) 18 is received and retained in the first groove 26, and is prevented from being further inserted into the hollow interior of the body 12 by an edge of the first lip 28, as best illustrated in FIG. 3. The−ye pcb 18 include the negative contact 20 fitted to a side exterior of the body 12. The negative contact 20 features a raised surface concentric with a recessed surface 22, thereby simulating a negative contact of a standard battery.

A battery or storage cell 50 is received in the hollow interior of the body 12, and features at least one groove 52 adjacent an end and along its circumference. The groove 52 is configured to receive a protrusion or ridge (now shown) extending interiorly from the body 12 to retain the battery 50 in the hollow interior of the body. The battery 50 can be, but not limited to, a Lithium Iron Phosphate (LiFePO4) battery, or any rechargeable battery or electrical storage cell. The battery 50 is sized so as to provide a gap between an exterior surface of the battery 50 and an interior surface of the body 12, thereby providing the ventilation of the hollow interior with the exterior of the body 12 via the ventilation holes 14. The battery 50 is retained between the first lip 28 and a flange 42 extending inwardly from the body 12.

The second end of the body 12 includes an interiorly tapering second edge 30, an interiorly extending second lip 34 in a spaced apart relationship with the second edge 30, and a second groove 32 defined between the second edge 30 and second lip 34 along an interior circumference of the body 12. The second edge 30 and the second lip 34 having a central defined opening that is in communication with the hollow interior for the body 12.

A positive printed circuit board or contact (hereinafter “+ye pcb”) 36 is received and retained in the second groove 32, and is prevented from being further inserted into the hollow interior of the body 12 by an edge of the second lip 34, as best illustrated in FIG. 4. The +ye pcb 36 include the positive contact 38 fitted to a side exterior of the body 12. The positive contact 38 features a raised surface concentric which tapers to a central nipple 40, thereby simulating a positive contact of a standard battery. The nipple 40 extends out past the second edge 30 thus allowing the nipple 40 to make contact with an electrical contact of the device 8.

A battery charge controller 54 is fitted between the flange 42 and the second lip 32, and is in electrical communication with the −ye pcb 18 via wiring 66, the battery 50 via wiring 64, and the +ye pcb 36. The wiring 64 can be, but not limited to, a three wire cable. The battery charge controller 54 has a printed circuit board 56 which includes a communication controller 58, a discharge controller 60, and in the alternative a global positioning system (GPS) module 62.

The battery charge controller 54 monitors constantly the demand by the external device 8 and makes decisions based on the time duration between current demands. The battery charge controller 54 can control different power output modes of the battery 50 to the device 8.

Referring to FIG. 5, the alternative embodiment battery module 10′ has the body 12, a RCA connection unit 72, and the positive contact end 38.

The body 12 generally has a cylindrical configuration with first and second ends, but it can have any geometric configuration which corresponds with a battery which is to be replaced. The body 12 features a plurality of ventilation holes 14 defined therethrough. The ventilation holes 14 are in communication with the hollow interior of the body 12.

The body 12 is similar to that of the battery module 10 and includes the interiorly tapering first edge 16, the interiorly tapering first lip 28 in a spaced apart relationship with the first edge 16, and the first groove 26 defined between the first edge 16 and first lip 28 along an interior circumference of the body 12.

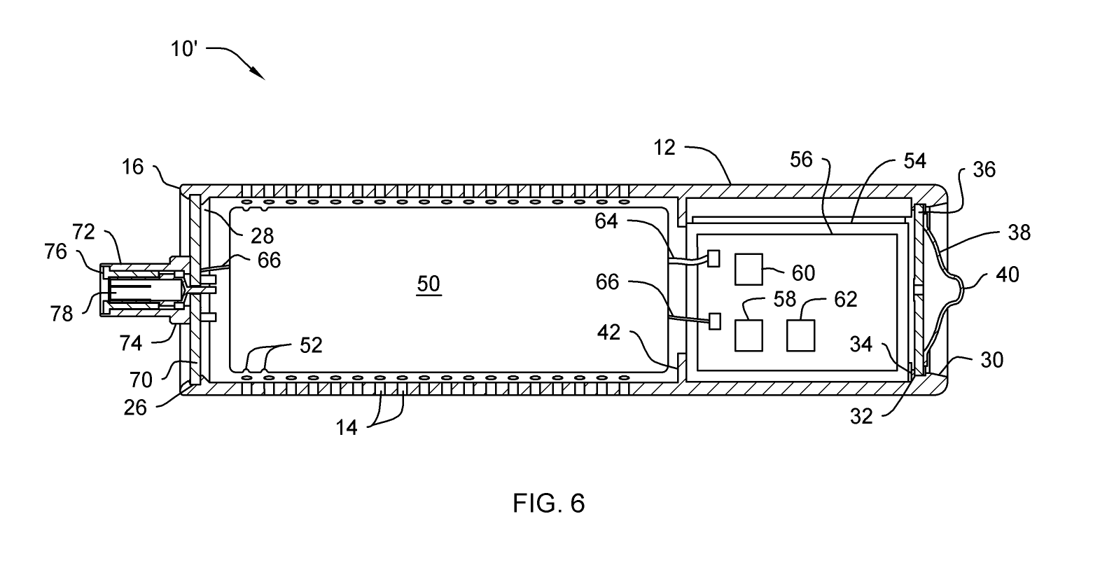

A negative printed circuit board or contact (hereinafter “−ye pcb”) 70 is received and retained in the first groove 26, and is prevented from being further inserted into the hollow interior of the body 12 by an edge of the first lip 28, as best illustrated in FIG. 6.

The RCA unit 72 includes a cylindrical body that features an enlarged edge 74 that is fitted to the −ye pcb 70 so as to extend out therefrom. Posts, latches or clips can be used to attach the enlarged edge 74 to the −ye pcb 70 in an electrically insulating manner. The RCA unit 72 includes an interior sleeve 76, and a concentric interior contact 78. The interior contact 78 is in electrical communication with the −ye pcb 70, and is configured to receive an RCA jack.

The wiring 66 electrically connects the −ye pcb 70 to the battery charge controller 54, thereby making the RCA unit 72 independent from the battery charge controller 54 and thus allowing the RCA unit 72 to be interchangeable with the alternate embodiment battery module 10′.

While embodiments of the rechargeable programmable intelligent variable output battery module have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. And although providing a replacement battery for a device which can be programmed to supply power output demanded by the device have been described, it should be appreciated that the rechargeable programmable intelligent variable output battery module herein described is also suitable for any portable power supply which includes a power storage device.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A battery module for providing programmable variable power output to a device, said battery module comprising:
a body having a first end, a second end, and a hollow interior defined between said first and second ends;
a first contact having at least one electrical contact surface, said first contact being attachable to said first end of said body;
a second contact having at least one electrical contact surface, said second contact being attachable to said second end of said body;
a battery located in said hollow interior of said body; and
a battery controller located in said hollow interior of said body, said battery controller being in electrical communication with said first contact, said second contact and said battery, said battery controller being configured to monitor an electrical demand by the device and to control an electrical discharge from said battery.

2. The battery module according to claim 1, wherein said first contact comprises a first exterior contact surface in communication with a first printed circuit board.

3. The battery module according to claim 2, wherein said first exterior contact surface of said first contact includes at least one raised section and at least one recessed section, wherein said raised section and said recessed section are concentric.

4. The battery module according to claim 1, wherein said second contact comprises a second exterior contact surface and a second printed circuit board.

5. The battery module according to claim 4, wherein said second exterior contact surface of said second contact includes a nipple that extends out from said second exterior contact surface.

6. The battery module according to claim 1, wherein said first end of said body includes a first edge that extends toward said hollow interior, a first lip that extends toward the hollow interior, and a first groove defined between said first edge and said first lip, said first groove receives at least a portion of said first contact.

7. The battery module according to claim 6, wherein said battery is retained between said first lip and a flange extending inwardly from an interior side of said body and toward said hollow interior.

8. The battery module according to claim 6, wherein said first edge tapers inwardly toward said first groove, and said first lip tapers inwardly toward said first groove.

9. The battery module according to claim 6, wherein said second end of said body includes a second edge that extends toward said hollow interior, a second lip that extends toward the hollow interior, and a groove defined between said second edge and said second lip, said second groove receives at least a portion of said second contact.

10. The battery module according to claim 9, wherein said second edge tapers inwardly toward said second groove, and said second lip tapers inwardly toward said second groove.

11. The battery module according to claim 1, wherein said body further comprises a plurality of ventilation holes defined through said body and in communication with said hollow interior.

12. The battery module according to claim 1, wherein said battery controller further comprises a discharge controller and a communication controller.

13. The battery module according to claim 12, wherein said wherein said battery controller further comprises a GPS module.

14. The battery module according to claim 1, wherein said first contact further comprises a RCA unit in communication with said first contact.

15. The battery module according to claim 1, wherein said battery module is configured to replace an existing battery of the device, and wherein said battery controller is configured to be programmable to supply a power output demanded by the device and to modulate the power output automatically based upon analysis of a current demanded of the device.

16. The battery module according to claim 1, wherein said batter controller is configured to monitor a power switch of the device in combination with a length of time between switching of the power switch, and to control a delivery of a programmed power output from said battery to the device.

17. The battery module according to claim 1, wherein said batter controller is configured to provide multiple levels of power outputs by one means selected from the group consisting of pulse width modulation, rapid switching of an output current, and a current limiting circuit that reduces an output voltage to maintain a programmed current delivery.
